(19) United States
(12) Patent Application Publication
(10) Pub. No.: US 2010/0171960 A1
(43) Pub. Date: Jul. 8, 2010

(54) FOR PATH IMBALANCE MEASUREMENT OF THE TWO ARMS FIBER OPTIC INTERFEROMETER

(75) Inventor: SHIH-CHU HUANG, Kaohsiung City (TW)

Correspondence Address: J C PATENTS, 4 VENTURE, SUITE 250, IRVINE, CA, 92618, US

(73) Assignee: NXTAR TECHNOLOGIES, INC., Tainan County (TW)

(21) Appl. No.: 12/350,118

(22) Filed: Jan. 7, 2009

(51) Int. Cl. G01B 9/02

(52) U.S. Cl. 356/477

(57) ABSTRACT

Path imbalance measurement of the two arms fiber optic interferometer includes employing a current carrier signal to modulate the semiconductor laser light source of the interferometer to let it output interference signals to generate a carrier phase signal through path imbalance of the interferometer. Then, the interference signals are expanded to be the harmonic components of carrier phase signal frequency by Bessel function. Subsequently, we use the specific relation between the second and the fourth harmonic components of the interference signals to develop the theory of path imbalance measurement. The method mentioned above can measure a few decimeters of path imbalance and its accuracy can reach to a millimeter.

### BACKGROUND OF THE INVENTION

1. Field of the Invention

This invention relates to path imbalance measurement of the two arms fiber optic interferometer, particularly to one using a polarization-insensitive fiber optic Michelson interferometer to measure the value of path imbalance. The method is to use a current carrier signal to modulate the semiconductor laser source of the interferometer to let it output interference signal to generate a carrier phase signal through path imbalance of the two arms fiber optic interferometer. Then, interference signals are expanded to become the harmonic components of carrier phase signal frequency. Subsequently, specific relation between the second and the fourth harmonic components of the interference signal are used to organize the theory of path imbalance measurement of the interferometer. This method can measure a few decimeters of path imbalance and its precision can reach to millimeters.

2. Background of the Invention

The sensing phase signal of the two arms fiber optic interferometer sensor (TAFOIS) requires linear demodulation by using some demodulation techniques. The passive homodyne demodulation using phase generated carrier (PGC) has many advantages such as wide dynamic range, good linearity, high sensitivity and sensor multiplexing.

Therefore, the PGC demodulator is widely used for demodulating signal of the FOIS. However, firstly, the PGC demodulation must generate a high frequency carrier phase signal with fixed amplitude. A method is applying a current modulation carrier signal to the semiconductor laser of the unbalanced interferometer to generate a carrier phase signal, and the amplitude of the carrier phase signal is proportional to the PI of the unbalanced interferometer. The constant PI of the interferometer is required to generate constant amplitude of the carrier signal by using current modulation to the semiconductor laser. Therefore, the accuracy of the PI (typically, the length of PI may be up to 200 mms) must achieve the range of mm. However, when the sensing fiber is produced by loose tube fiber or the sensing fiber length is more than a few hundred meters, the error of the initial cutting fiber length can approximate a few decimeters, so we need a method that the PI detecting range can achieve a few decimeters and its accuracy can be in the range of millimeter.

Currently, methods to measure larger OPD include using precision optical low coherence reflectometry (OLCR) and millimeter optical time domain reflectometry (mm-OTDR). Both methods are based on measuring high-spatial resolution of the reflected optical signal, so the price of the instrument is very high. Although OLCR has high resolution, its OPD measuring range is generally a few centimeters.

On the other hand, the resolution of mm-OTDR is limited in about 5 mm. So both methods can not fit the demands above.

In this invention, we propose a method to measure the PI by using the output interference signal of the fiber optic Michelson interferometer. We use a current modulation carrier signal to the semiconductor laser of the unbalanced interferometer to generate a carrier phase signal, and we expand the interference signal by using the Bessel function. Then we use the specific relation between the second and fourth harmonic components of the interference signal to develop the theory of the PI measurement. The method can measure a few decimeters of PI and its accuracy can reach to a millimeter.

### SUMMARY OF INVENTION

The objective of this invention is to offer an optical fiber length measurement, which uses path imbalance of a polarization-insensitive fiber optic Michelson interferometer (PIFOMI) to accurately measure the value of path imbalance.

Path imbalance measurement of the two fiber optic interferometer in the present invention is to use path imbalance formed between an arm (A) and an arm (B) of the polarization-insensitive fiber optic Michelson interferometer to measure the value of path imbalance of the two arms. The method is to use a current carrier signal to modulate the semiconductor laser source of the interferometer to let it output interference signal to generate a carrier phase signal by means of path imbalance of the interferometer, and then the interference signal are expanded to become the harmonic components of carrier phase signal frequency. Subsequently, we use the specific relation between the second and the fourth harmonic components of the interference signals to develop the theory of path imbalance measurement. This method can measure a few decimeters of path imbalance and its precision can attain to millimeters.

Path imbalance measurement of the two arms fiber optic interferometer according to this invention is to have the arm (A) and the arm (B) of the interferometer respectively provided with a sensing optical fiber and a reference optical fiber. The arm (B) is further disposed with a PZT phase modulator functioning to change phase shift and in a certain period pick plural sets of interference signals whose second and fourth harmonic components respectively reach maximum values. The measured values of path imbalance of plural sets of the interference signals can be calculated, obtained and then averaged out to get an average measured value to be used for measuring the length of the optical fiber, thus effectively reducing errors of measurement.

### BRIEF DESCRIPTION OF DRAWINGS

This invention will be better understood by referring the accompanying drawings, wherein:

FIG. 1. The curves of the first kind Bessel function (n=1˜4) as a function of the phase Δφ₀(0˜6 rads).

FIG. 2. The curve of the 20 log [J₂(Δφ₀)/J₄(Δφ₀)] as a function of the amplitude of the modulation phase signal Δφ₀(0˜5.135 rads).

FIG. 3. The PI measurement system with PIFOMI.

FIG. 4. The components of 1 kHz and 3 kHz spectrums of the output signal are equal for measurement low frequency response of the PZT phase modulator.

FIG. 5. The input signal of the PZT phase modulator is a triangle wave with an amplitude of 5V, and the period is 100s.

FIG. 6. The waveform of the output interference signal in a period (100 ms) with six extreme values for the carrier phase signal Δφ(t)=4.12 rads.

FIG. 7. The harmonic spectrums of the output interference signal, and the values of 2^{nd} and 4^{th} harmonic spectrums are maximum for sin φ_{T}(t)=0.

FIG. 8. The harmonic spectrums of the output interference signal, and the values of 1^{st} and 3^{rd} harmonic spectrums are maximum for cos φ_{T}(t)=0.

FIG. 9. The waveform of the output interference signal in a period (100 ms) with ten extreme values for the carrier phase signal Δφ(t)=8.4 rads.

FIG. 10 The measurement results Table 1-1 & 1-2

### DETAILED DESCRIPTION OF THE PREFERRED EMBODIMENT

### 1. The Theory of the PI Measurement of the Two Arms Fiber Optic Interferometer

If the fiber optic Michelson interferometer is constructed of regular single-mode fiber, fluctuation of the interference output occurs easily because of polarization-induced signal fading. To avoid the fading effect, the polarization-insensitive fiber optic Michelson interferometer (PIFOMI) was proposed in this paper to measure the PI. The PIFOMI includes two Faraday rotator mirrors (FRM) which can eliminate polarization fading by compensation of birefringence effect in a retraced fiber path. We assume the PI of the unbalanced PIFOMI is ΔL.

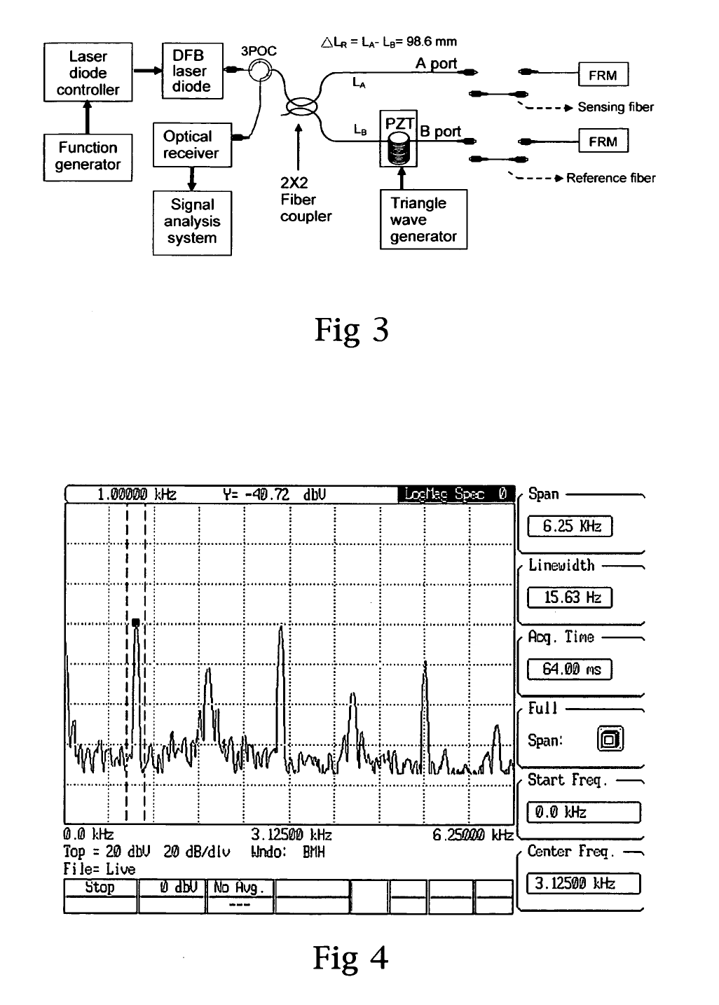

Therefore, in FIG. 3, we can apply a current modulation signal Δi sin ω_{c}t to the semiconductor laser to generate a carrier phase signal Δφ(t). The Δφ(t) can be expressed as

$$Δ φ ( t ) = \frac{2 π Δ Ln}{c} Δ i \frac{δ v}{δ i} sin {ω}_{c} t = Δ {φ}_{0} sin {ω}_{c} t , \qquad ( 1 )$$

where

$$Δ {φ}_{0} = \frac{2 π Δ Ln}{c} Δ i \frac{δ v}{δ i}$$

is the amplitude of the modulation phase signal, n in the above equation is the refractive index of the fiber core, c is the light velocity, and

$$\frac{δ v}{δ i}$$

is the effective current to frequency conversion factor of the semiconductor laser. Furthermore, the current modulation signal Δ/i sin ω_{c}t will generate a small intensity modulation simultaneously.

In general the intensity modulation can be neglected in the PGC demodulation, but the effect of the intensity modulation must be considered as used to measure the PI. Assuming that the output power intensity of the semiconductor laser is changed from I₀ to I₀ (1+α sin ω_{c}t where a should be proportional to Δi, and the interference signal output I(t) of the unbalanced PIFOMI is given by

I(t)=b(1+α sin ω_{c}t){1+k cos [φ(t)+Δφ sin ω_{c}t]} (2)

where b should be proportional to I₀, and the phase biased φ(t) is fluctuated according to environment change. The Eq. (3) can be obtained after using the Bessel function to expand Eq. (2) as follows:

$$I ( t ) = b ( 1 + a sin {ω}_{c} t ) \{ \begin{matrix}1 + k [ \begin{matrix}{J}_{0} ( Δ {φ}_{0} ) + \\ 2 {\sum }_{n = 1}^{∞} {J}_{2 n} ( Δ {φ}_{0} ) \\ cos 2 ( n {ω}_{c} t )\end{matrix} ] cos φ ( t ) - \\ [ \begin{matrix}2 {\sum }_{n = 0}^{∞} {J}_{2 n + 1} ( Δ {φ}_{0} ) \\ sin ( ( 2 n + 1 ) {ω}_{c} t )\end{matrix} ] sin φ ( t )\end{matrix} \} \qquad ( 3 )$$

Eq. (3) can be expanded further to obtain the amplitudes of the ω_{c}, 2ω_{c}, 3ω_{c} and 4φ_{c} harmonic components are A(ω_{c}), A(2ω_{c}), A(3ω_{c}) and A(4ω_{c}) respectively which are given by

A(ω_{c})=bα−2bkJ₁(Δφ₀)sin φ(t)+[bαkJ₀(Δφ₀)−bαkJ₂(Δφ₀)] cos φ(t), (4)

A(2ω_{c})=[2bkJ₂(Δφ₀)] cos φ(t)+[bαkJ₁(Δφ₀)−bαkJ₃(Δφ₀)] sin φ(t), (5)

A(3ω_{c})=[bαkJ₂(Δφ₀)−bαkJ₄(Δφ₀)] cos φ(t)−[2bkJ₃(Δφ₀)] sin φ(t), (6)

A(4ω_{c})=[2bkJ₄(Δφ₀)] cos φ(t)+[bαkJ₃(Δφ₀)−bαkJ₅(Δφ₀)] sin φ(t). (7)

Considering the four components above, when cos φ(t)=0 we can obtain the results as follows:

A(ω_{c})=bα−2bkJ₁(Δφ₀)sin φ(t), (8)

A(2ω_{c})=[bαkJ₁(Δφ₀)−bαkJ₃(Δφ₀)] sin φ(t), (9)

A(3ω_{c})=−[2bkJ₃(Δφ₀)] sin φ(t), (10)

A(4ω_{c})=[bαkJ₃(Δφ₀)−bαkJ₅(Δφ₀)] sin φ(t). (11)

Obviously A(ω_{c}), A(2ω_{c}) and A(4ω_{c}) have the laser intensity modulation coefficient α, and A(3ω_{c}) is independent of α. A(2ω_{c}) and A(4ω_{c}) are proportional to α, and therefore A(2ω_{c}) as well as A(4ω_{c}) are minor components compared with A(ω_{c}) and A(3ω_{c}) since α<<1. That means A(2ω_{c}) and A(4ω_{c}) are effected easily by the noise. The ratio of A(ω_{c})/A(3ω_{c}) can be calculated as

$$\frac{A ( {ω}_{c} )}{A ( 3 {ω}_{c} )} = \frac{ba - 2 {bkJ}_{1} ( Δ {φ}_{0} ) sin φ ( t )}{- [ 2 {bkJ}_{3} ( Δ {φ}_{0} ) ] sin φ ( t )} . \qquad ( 12 )$$

The A(ω_{c})/A(3ω_{c}) depends on α and sin φ(t), and therefore the ratio of the A(ω_{c})/A(3ω_{c}) is not suitable to calculate Δφ₀. When sin φ(t)=0, the four components of Eq. (4) to Eq. (7) can be reduced to as follows:

A(ω_{c})=[bαkJ₀(Δφ₀)−bαkJ₂(Δφ₀)] cos φ(t), (13)

A(2ω_{c})=[2bkJ₂(Δφ₀)] cos φ(t), (14)

A(3ω_{c})=[bαkJ₂(Δφ₀)−bαkJ₄(Δφ₀)] cos φ(t), (15)

A(4ω_{c})=[2bkJ₄(Δφ₀)] cos φ(t). (16)

Eq. (13) to Eq. (16) show that while sin φ(t)=0, A(ω_{c}) and A(3ω_{c}) are dependent of α; furthermore A(2ω_{c}) and A(4ω_{c}) are independent of α, and the values of A(2ω_{c}) and A(4ω_{c}) achieve their maximums, individually. From Eq. (14) and Eq. (16), we find the ratio of the A(2ω_{c})/A(4ω_{c})=J₂(Δφ₀)/J₄(Δφ₀) is only dependent the amplitude of the modulation phase signal Δφ₀. The J₂(Δφ₀)/J₄(Δφ₀) and Δφ₀ is one-to-one correspondence function within a specified region of Δφ₀. The condition of the sin φ(t)=0 can be accomplished by adjusting DC bias voltage to the PZT phase modulator on a fiber arm of the FOIS, and the intensities of the frequency spectrums of the interference signal output I(t) can be analyzed by the frequency spectrum analyzer (FSA) to calculate the Δφ₀ from the measurement value of the J₂(Δφ₀)/J₄(Δφ₀). The intensities of the frequency spectrums of the FSA which are properly expressed as decibel, therefore we prefer using the 20 log [J₂(Δφ₀)/J₄(Δφ₀)] to replace the J₂(Δφ₀)/J₄(Δφ₀) in the following theoretical analysis.

Here we use LabView software to figure out the values of Bessel function of the first kind of order n (n=1˜4) with the phase Δφ₀(0˜6 rads).

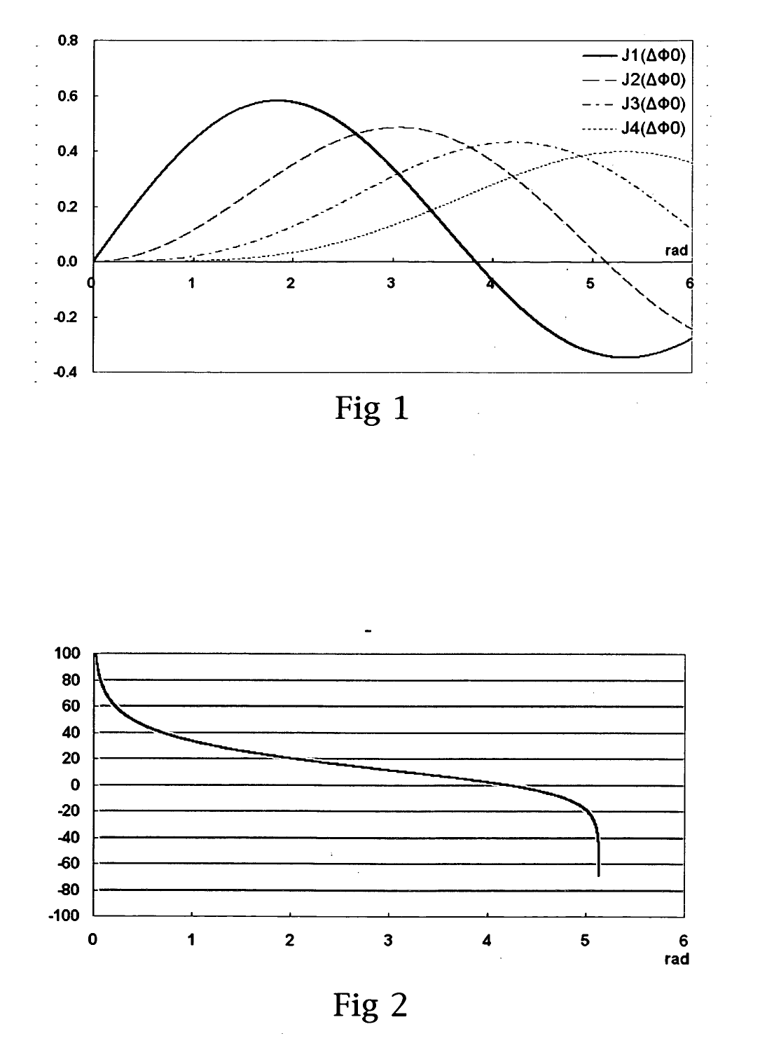

Four lines in FIG. 1 from left to right are, J₁(Δφ₀) J₂(Δφ₀), J₃(Δφ₀) and J₄(Δφ₀), respectively. Theoretically, in the first periodic of J₂(Δφ₀)>0 (0<Δφ₀<5.135 rads), the J₂(Δφ₀)/J₄(Δφ₀) and Δφ₀ is one-to-one correspondence function, and the curve of the 20 log [J₂(Δφ₀)/J₄(Δφ₀)] as a function of the amplitude of the modulation phase signal Δφ₀ (0˜5.135 rads) is shown as FIG. 2. Since A(2ω_{c}) and A(4ω_{c}) are proportion to J₂(Δφ₀) and J₄(Δφ₀) respectively, if either of A(2ω_{c}) and A(4ω_{c}) is small, it can be severely interfered with noise in measurement and therefore have lower accuracy.

For example, if J₂(Δφ₀)≧0.1 and J₄(Δφ₀)≧0.1 are considered, we can get 2.744 rads≦Δφ₀≦4.846 rads. In order to decrease the effect of background noise and improve the accuracy and stability, we will require reasonably that the experimental procedures should be properly arranged in measurement to make sure that 20 log [J₂(Δφ₀)/J₄(Δφ₀)] is in the optimum range of −3 dB≦ 20 log [J₂(Δφ₀)/J₄(Δφ₀)]≦3 dB, i.e. 3.927 rads≦Δφ₀≦4.429 rads.

According to Eq. (1), the Δφ₀ is proportional to the path imbalance ΔL. We first choose proper Δφ_{R} (typically, choosing 20 log [J₂(Δφ_{R})/J₄(Δφ_{R})]≈0, therefore Δφ_{R}≈4.2 rads) as the reference of measurement. By making a standard PIFOMI whose two arms have a given path imbalance ΔL_{R} (which must be measured accurately by ruler) as the measurement reference. Then, we will adjust the DC current and modulation current amplitude on the semiconductor laser properly to approach J₂(Δφ_{R})=J₄(Δφ_{R}) of the output interference signal of the standard PIFOMIS, and the current modulation signal is represented as Δi₀ sin ω_{c}t. According to the values of the first kind Bessel function, we can obtain the reference value of Δφ_{R}.

While measuring the unknown PIFOMI of two fiber arms whose path imbalance is ΔL_{D}, we keep the DC current on the semiconductor laser. According to the ratio of ΔL_{D} and ΔL_{R}, there are two cases shown as follow:

$$If 0.935 \leq \frac{Δ {L}_{D}}{Δ {L}_{R}} \leq 1.054 , \qquad ( a )$$

the corresponding phase amplitude Δφ₀ of the I(t) will be represented as Δφ_{D} to conform −3 dB≦20 log [J₂(Δφ_{D})/J₄(Δφ_{D})]≦3 dB, and the current modulation signal is keep as Δi₀ sin ω_{c}t. When sin φ(t)=0 (the values of A(2ω_{c}) and A(4ω_{c}) become maximum), from Eq. (1) the amplitude of the simulated phase signal in the output signal of interferometer is proportion to the length difference of interferometer's two arms. Thus ΔL_{D}, the length difference of fiber optics of interferometer's two arms can be expressed as,

ΔL_{D}=(Δφ_{D}/Δφ_{R})ΔL_{R}. (17)

(b) If

$$0.935 > \frac{Δ {L}_{D}}{Δ {L}_{R}}$$

or

$$1.054 < \frac{Δ {L}_{D}}{Δ {L}_{R}} ,$$

the current modulation signal will be multiplied by a coefficient h to become as hΔi₀ sin ω_{c}t, and the corresponding phase amplitude Δφ₀ of the I(t) will be represented as Δφ_{D} still to conform −3 dB≦20 log [J₂(Δφ_{D})/J₄(Δφ_{D})]≦3 dB. Therefore, the specific range

$$0.935 \leq \frac{h Δ {L}_{D}}{Δ {L}_{R}} \leq 1.054$$

of the

$$\frac{h Δ {L}_{D}}{Δ {L}_{R}}$$

is obtained. When sin φ(t)=0, from Eq. (1) we get the path difference of fiber optics of interferometer's two arms, i.e. ΔL_{D}, can be expressed as,

$$Δ {L}_{D} = \frac{Δ {φ}_{D}}{h Δ {φ}_{R}} Δ {L}_{R} . \qquad ( 18 )$$

Supposing that the fiber's length of two arms of the interferometer is L and (L+ΔL), respectively, since our technique is to measure ΔL directly, it is the component's proportion 20 log [J₂(Δφ₀)/J₄(Δφ₀)] of the 2^{nd} and 4^{th} frequency of interference signals that determines ΔL. Obviously, 20 log [J₂(Δφ₀)/J₄(Δφ₀)] is independent to L, and therefore the accuracy would not decrease while L is larger, which is a big advantages.

### 2. The Effect Analysis of the Environment Noise on the PI Measurement

We have mentioned that if either of the 2^{nd} and 4^{th} frequency of interferometer's output signal (namely, A(2ω_{c}) and A(4ω_{c})) is small, the accuracy may be affected by the noise easily. In the matter of fact, even if Δφ_{D} is in the ideal range, 3.927 rads≦Δφ_{D}≦4.429 rads, while the environment noise is big enough it may still interfere the 2^{nd} and 4^{th} components and moreover affect the accuracy. If the single-phase-noise from the surrounding is φₑₙ sin ωₑₙt, Eq. (2) of the interference signal output I(t) of the unbalanced PIFOMIS can be replaced by

I(t)=b(1+α sin ω_{c}t){1+k cos [φ(t)+φₑₙ sin ωₑₙt+Δφ sin ω_{c}t]}, (19)

the Eq. (20) can be obtained after using the Bessel function to expand Eq. (19) as follows:

$$I ( t ) = b ( 1 + a sin {ω}_{c} t ) \{ \begin{matrix}1 + k [ \begin{matrix}{J}_{0} ( Δ {φ}_{0} ) + \\ 2 {\sum }_{n = 1}^{∞} {J}_{2 n} ( Δ {φ}_{0} ) \\ cos 2 ( n {ω}_{c} t )\end{matrix} ] cos [ φ ( t ) + {φ}_{en} sin {ω}_{en} t ] - \\ [ \begin{matrix}2 {\sum }_{n = 0}^{∞} {J}_{2 n + 1} ( Δ {φ}_{0} ) \\ sin ( ( 2 n + 1 ) {ω}_{c} t )\end{matrix} ] sin [ φ ( t ) + {φ}_{en} sin {ω}_{en} t ]\end{matrix} \} . \qquad ( 20 )$$

Eq. (20) can be expanded further to obtain the amplitudes around 2ω_{c} and 4ω_{c} harmonic waves are A_{2ω}_{_{c}}(t) and A_{4ω}_{_{c}} (t) respectively which are given by

$$\begin{matrix}{A}_{2 {ω}_{c}} ( t ) = [ 2 {bkJ}_{2} ( Δ {φ}_{0} ) ] cos [ φ ( t ) + {φ}_{en} sin {ω}_{en} t ] + [ {bakJ}_{1} ( Δ {φ}_{0} ) - {bakJ}_{3} ( Δ {φ}_{0} ) ] sin [ φ ( t ) + {φ}_{en} sin {ω}_{en} t ] , & ( 21 ) \\ {A}_{4 {ω}_{c}} ( t ) = [ 2 {bkJ}_{4} ( Δ {φ}_{0} ) ] cos [ φ ( t ) + {φ}_{en} sin {ω}_{en} t ] + [ {bakJ}_{3} ( Δ {φ}_{0} ) - {bakJ}_{5} ( Δ {φ}_{0} ) ] sin [ φ ( t ) + {φ}_{en} sin {ω}_{en} t ] . & ( 22 )\end{matrix}$$

Commonly, the noise is composed of many frequencies; therefore we can make reasonable hypothesis that φₑₙ<<Δφ₀. Considering ωₑₙ and ω_{c}, there are two cases, discussed below:

(a) If ωₑₙ<<ω_{c}, the extra spectrum components of the 2ω_{c} and 4ω_{c} are induced by cos [φ(t)+φₑₙ sin ωₑₙt] in Eq. (21) and Eq. (22) can be ignored. When sin φ(t)=0, A(2ω_{c}) and A(4ω_{c}) in Eq. (21) and Eq. (22) can be reduced as

A(2ω_{c})=[2bkJ₂(Δφ₀)]J₀(φₑₙ)cos φ(t), (23)

A(4ω_{c})=[2bkJ₄(Δφ₀)]J₀(φₑₙ)cos φ(t), (24)

Therefore, from Eq. (23) and Eq. (24), we can find the effect of the phase noise φₑₙ sin ωₑₙt is just multiplied by the modification term J₀(φₑₙ) comparing to Eq. (14) and Eq. (16), which are less than 1. Thus, the proportion of A(2ω_{c})/A(4ω_{c}) is still J₂(Δφ₀)/J₄(Δφ₀).

(b) If ωₑₙ is not much smaller than ω_{c} and the noise is broadband, we can especially consider the specific noise ωₑₙ=mω_{c} (where m is a positive integer less than or equal to 4) and ωₑₙ=ω_{c}/n (n is a positive integer larger or equal to 2) that influence the measurement larger. When the amplitudes are the same, the noise of the frequency ωₑₙ=ω_{c} influences the measurement result the most. Here we use only this component to estimate the influence on the measurement. While ωₑₙ=ω_{c}, supposing that the component is φₑₙ sin ω_{c}t, if sin φ(t)=0, we have φₑₙ sin ωₑₙt+Δφ sin ω_{c}t=(φₑₙ+Δφ)sin ω_{c}t (Eq. (19)), and the amplitudes of the 2ω_{c} and 4ω_{c} of the Eq. (19) harmonic waves are A(2ω_{c}) and A(4ω_{c}) respectively which must be modified as

A(2ω_{c})=[2bkJ₂(Δφ₀+φₑₙ)] cos φ(t), (25)

A(4ω_{c})=[2bkJ₄(Δφ₀+φₑₙ)] cos φ(t). (26)

From Eq. (25) and Eq. (26), it is given that A(2ω_{c})/A(4ω_{c})=J₂(Δφ₀+φₑₙ)/J₄(Δφ₀+φₑₙ). Therefore, the proportion A(2ω_{c})/A(4ω_{c}) will change with the phase noise amplitude φₑₙ, and the relation A(2ω_{c})/A(4ω_{c})=J₂(Δφ₀)/J₄(Δφ₀), which must be required for the accurate measurement, does not exist anymore.

Combining the conclusion of (a) and (b), under the environment noise which contains mostly low frequencies (generally, the frequencies of the predominant environment noise spectrums are less than 5 kHz), the influence of the environment noise can be reduced obviously if it satisfies (ω_{c}/2π)≧10 kHz. In other way, if we can decrease the induced phase noise produced by the environmental noise on the interferometer efficiently, (for example, to put interferometer on the vibration-free optic table and control the temperature of the room at stability condition) then the higher accuracy is achieved.

### 3. Experiment and Application

In this experiment we use PIFOMI, as shown in FIG. 3, and use Fitel butterfly DFB laser with the maximum current 80 mA as the source. The light is connected the port 1 of the 3 port optical circulator (3POC) (2) to reduce optical feedback. The output light from the port 2 (20) of the 3POC is split by the 2×2 coupler into two fiber arms(A·B) of the PIFOMI, with PZT phase modulator (5) in one arm(A) and the path imbalance between two arms. The interference signal output from the port 3 (32) of the 3POC is converted by the optical receiver (70) to electric signal, and then we use FSA to analyze this signal.

We use ILX3724 B as laser diode controller (10) with external modulation performance. The ratio of the current to the external modulation voltage is 20 m A/V.

In order to reduce the effect of the environment noise, we prefer the modulation signal with high frequency (10 kHz) and put interferometer on the vibration-free optic table. In this experiment, the frequency spectrum analysis is executed by NI6250 DAQ card with frequency spectrum function in LabView software in PC. The advantages are that we can use PC to further analyze the result directly and that it is cheap.

To measure the PI of the PIFOMI, it must satisfy sin φ(t)=0 (the values of A(2ω_{c}) and A(4ω_{c}) become maximum), and then we can get the correct value of 20 log [J₂(Δφ₀)/J₄(Δφ₀)]. However, the phase φ(t) will vary with environment condition, (such as temperature, vibration and sound pressure), called dynamic variation. Thus we must use the PZT phase modulator to generate a phase signal φ_{PZT}(t) with sufficient large variation. The total phase biased become φ_{T}(t)=φ(t)+φ_{PZT}(t); meanwhile, FSA should continuously analyze the frequency spectrum of the output interference signal to ensure to get almost exact value of 20 log [J₂(Δφ₀)/J₄(Δφ₀)] while sin φ_{T}(t)=0. The frequency response of the PZT phase modulator at low frequency (typically, DC to 1 kHz) can be measured by using the output interference signal of the PIFOMI as shown in FIG. 3.

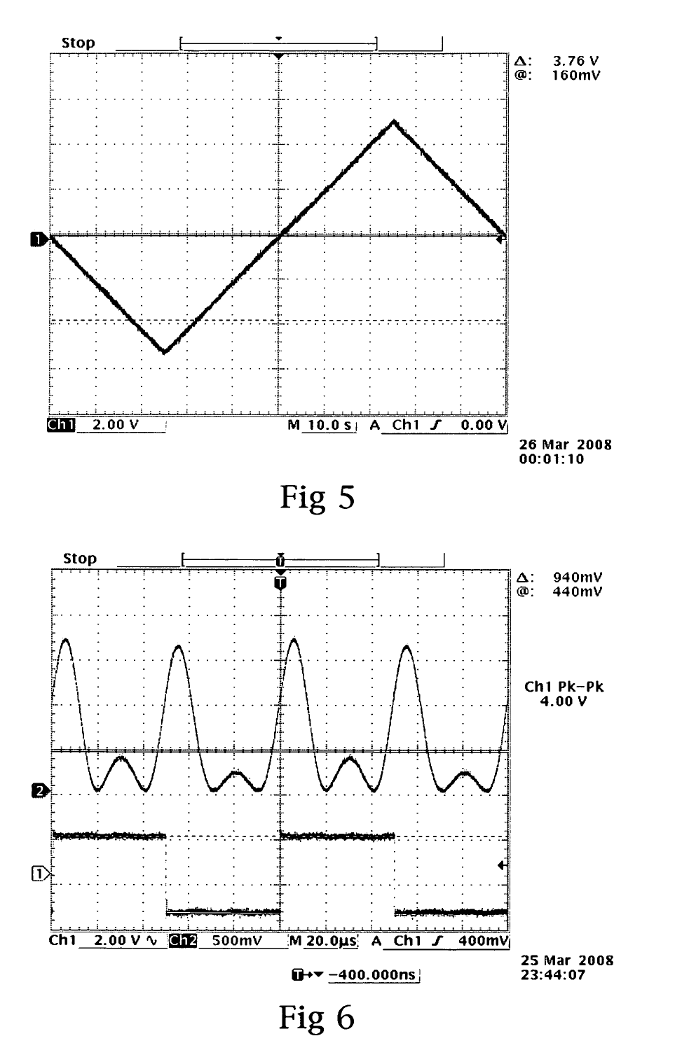

Here we use function generator to generate a 1 kHz sine wave to PZT phase modulator (the resonant frequency of the PZT phase modulator is much larger than 1 kHz), and here we use SR770 FSA to analyze this signal. Slowly increasing the amplitude, we find that on 4.415V the components of 1 kHz and 3 kHz are equal as shown in FIG. 4. From FIG. 1 it is obvious that the phase amplitude is 3.054 rads. Therefore the low frequency response of the PZT phase modulator is 0.69 rad/V. The input signal of the PZT phase modulator is a triangle wave with an amplitude of 5V (to generate a linear phase change), and the frequency is 10 mHz (the period is 100s), as shown in FIG. 5.

In 50s (or a half period), the phage change of PZT is 6.92 rads, so there are two chances to approach the condition φ_{T}(t)=mπ (where m is an integer), or sin φ_{T}(t)=0.

Moreover, 300s is such a sufficient long that FSA will have many chances (at least 12) to record those spectrums when sin φ_{T}(t)=0 and to compute corresponding phase values Δφ₀ of 20 log [J₂(Δφ₀)/J₄(Δφ₀)].

The program will choose five largest values of 2^{nd} harmonic spectrum of the output interference signal during 300s to obtain five phase values. To average five phase values, we get the average phase Δφ_{0,k} (kth time experiment) as this measurement result. By this way we can try to reduce the effect of the environmental noise and the inaccuracy (slight deviation from sin φ_{T}(t)=0) in sampling time. In following experiments of (A) and (B), we make five independent measuring for individual PI of the PIFOMI, and the result are Δφ_{0,k}(k=1˜5), respectively. The average Δφ_{0,mean} can be expressed as

$$Δ {φ}_{0 , mean} = \frac{Δ {φ}_{0 , 1} + Δ {φ}_{0 , 2} + Δ {φ}_{0 , 3} + Δ {φ}_{0 , 4} + Δ {φ}_{0 , 5}}{5} , \qquad ( 27 )$$

and the corresponding standard deviation S of the five measuring is

$$S = \sqrt{\frac{\begin{matrix}{( Δ {φ}_{0 , 1} - Δ {φ}_{0 , mean} )}^{2} + {( Δ {φ}_{0 , 2} - Δ {φ}_{0 , mean} )}^{2} + … + \\ {( Δ {φ}_{0 , 5} - Δ {φ}_{0 , mean} )}^{2}\end{matrix}}{5}} . \qquad ( 28 )$$

To get higher reliability and stability, we will use the average Δφ_{0,mean} to calculate the measuring value of the PI, and compare with results from an accurate ruler. Besides, the smaller the standard deviation S is, the more reliable Δφ_{0,mean} will be. On the other hand, bigger S means the measuring value are greater effected by the environment noise. Thus, we can set a reference value (typically 0.5 mm for the experiment). An excess S implies a worse accuracy.

The first procedure is to set the PIFOMI with standard PI. Two arms of the PIFOMI are just a few meters long, so it is convenient measuring their length with a ruler (here we need not to get the whole length of two arms, we care PI only).

In other hand, we have made optical connectors on two arms of the standard PIFOMI. When we re-start the PI measurement system (the instruments had been shut off), we should use the standard PIFOMI to calibrate the response of the whole optical circuit, and use it as the reference to measure the PI between the unknown fiber and its reference fiber.

In practical, we make a reference fiber with specified length (the length need not require absolute accurate), then use it as a standard to make sensing fiber with the same length. While measuring, the reference fiber and sensing fiber are connected to two arms of the standard PIFOMI with optical connectors in order to get PI. In this paper, our experiment can be divided into three parts, as shown in the following:

(A) Standard PI Measurement of the PIFOMI

By making a standard PIFOMI shown as FIG. 3 whose two arms (indicated as arm A with length L_{A} and arm B with length L_{B}) have a given path imbalance (PI) ΔL_{R}=L_{A}−L_{B}=98.6 mm (which must be measured accurately by ruler) as the measurement reference. Then, we will adjust the DC current and modulation current amplitude on the semiconductor laser properly to approach J₂(Δφ_{R})=J₄(Δφ_{R}) (here we choose the minimum of Δφ_{R} that approaches the condition J₂(Δφ_{R})=J₄(Δφ_{R}) the most. Namely, Δφ_{R} that approaches 4.2 rads) of the output interference signal of the standard PIFOMI. With appropriate choices, we find that using ultra-low distortion function generator DS 360 to generate a 10KHz modulation signal with 200 mV amplitude and adjust the DC current to 60.5 mA, the frequency spectrum of the output interference signal will approach J₂(Δφ_{R})=J₄(Δφ_{R}) very much. The waveform of the output interference signal is shown as FIG. 6.

Since Δφ_{R} approaches to 4.2 rads, in a period the output interference signal of the standard PIFOMI with approach six extreme values (maximum and minimum). Besides, with the variance of φ_{T}(t) the frequency spectrum of the output interference signal will change.

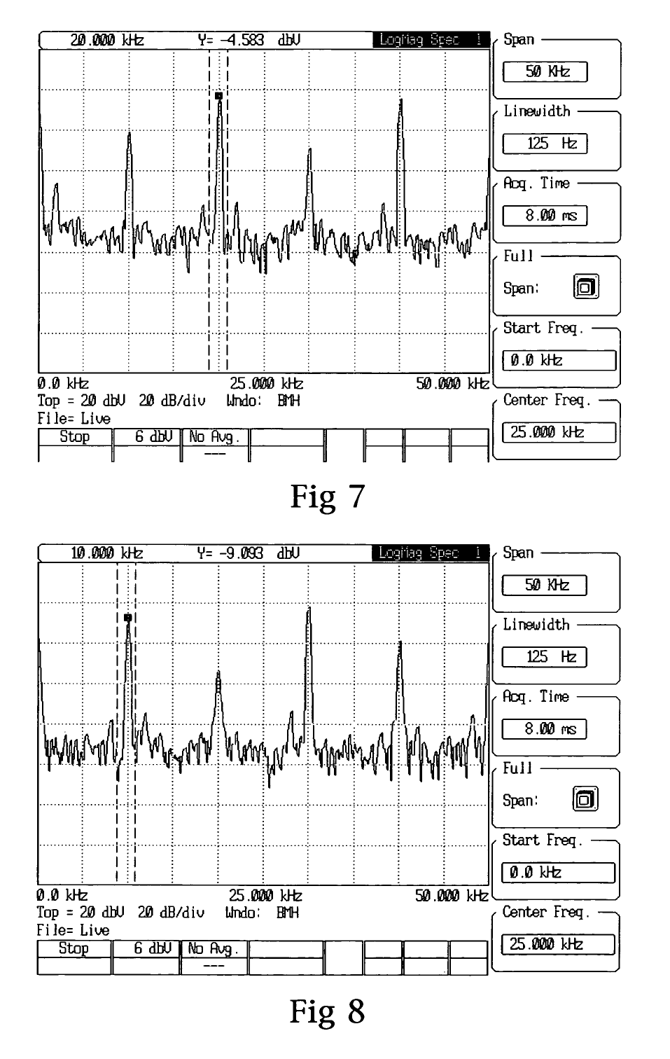

When sin φ_{T}(t)=0, the values of 2^{nd} and 4^{th} harmonic spectrums of the output interference signal are extreme maximum as shown in FIG. 7, and here we use SR770 FSA to analyze this signal.

Correspondingly, when cos φ_{T}(t)=0, the values of 1^{st} and 3^{rd} harmonic spectrums of the output interference signal are extreme maximum as shown in FIG. 8.

As the former discussion, the program automatically chooses five corresponding frequency spectrums, in which their 2^{nd} harmonic spectrums reach the five largest values during 300s, and calculates five phase values. The average phase during 300s is Δφ_{0,k}. The results from five individual measurements (each time need 300s) are 4.1328 rads, 4.1231 rads, 4.1246 rads, 4.1253 rads and 4.1268 rads, respectively, as shown in table 1-1, and the average value Δφ_{s tan dard, mean}=4.127 rads. In our setting, the measuring phase signal Δφ_{s tan dard, mean}=4.127 rads, and the corresponding PI ΔL_{R}=98.6 mm.

It can be thought as the response of standard PIFOMIS is 23.89 mm/rad while the amplitude of the modulation signal is 200 mV. Based on this response, we can calculate reversely to get the standard PIFOMI corresponding to those measuring phases are 98.55 mm, 98.54 mm, 98.57 mm, 98.59 mm and 98.63 mm. The standard deviation S=0.031 mm, which is much smaller than S=0.5 mm we set.

(B) Accuracy Measurement of Some PIs of the PIFOMI

In this experiment, we have made five pigtailed fibers with connectors at both ends whose lengths measured accurately by ruler are L₁=299.8 mm, L₂=219.5 mm, L₃=400.3 mm, L₄=538.2 mm, and L₅=678.5 mm, respectively. We will arrange the some pigtailed fibers connecting to both arms of the standard PIFOMI (path imbalance ΔL_{R}=L_{A}−L_{B}=98.6 mm) to obtain the seven different PI PIFOMIs, and these PI values are L_{PI,1}=L₁+L_{B}−L_{A}=201.2 mm, L_{PI,2}=L₂+L_{A}−L_{B}=318.1 mm, L_{PI,3}=L₁+L_{A}−L_{B}=398.4 mm L_{PI,4}=L₃+L_{A}−L_{B}=498.9 mm, L_{PI,5}=L₄+L_{A}−L_{B}=636.8 mm L_{PI,6}=L₅+L_{A}−L_{B}=777.1 mm and L_{PI,7}=L₂+L₅+L_{A}−L_{B}=996.6 mm respectively.

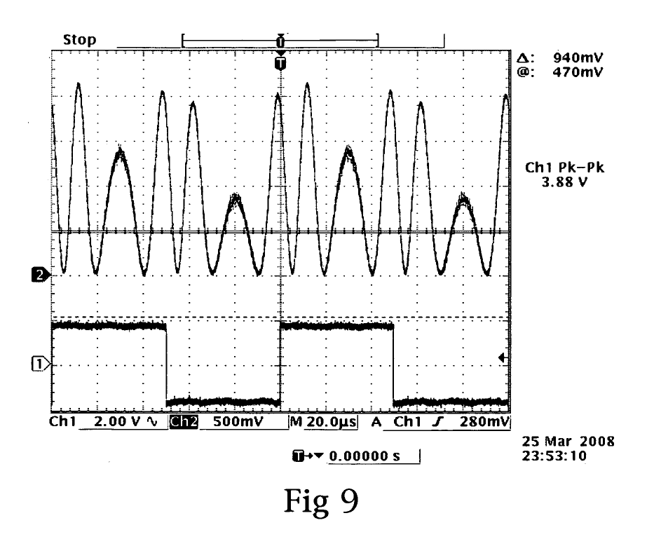

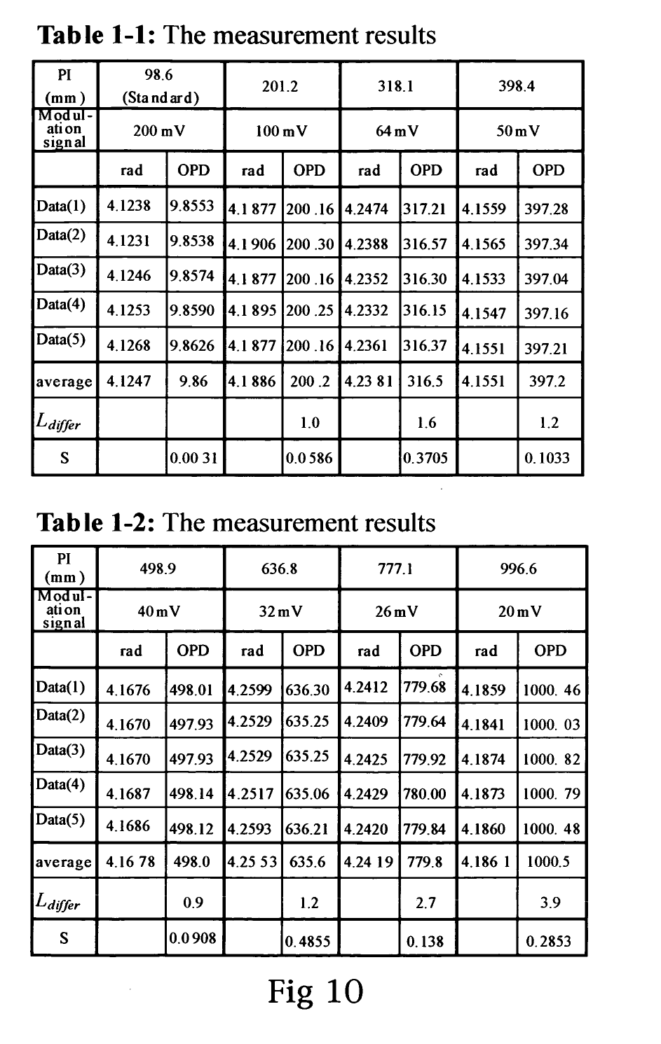

Thus, when we modulate the 10KHz signal with 200 mV amplitude, these Δφ₀ of the seven different PI PIFOMISs are much bigger than 4.12 rads. For example, we can calculate Δφ_{R} approach to 8.4 rads for L_{PI,1}=201.2 mm, and therefore the waveform of the output interference signal in a period with ten extreme values is shown as FIG. 9. In order to conform Δφ_{D} to the proper measurement condition −3 dB≦20 log [J₂(Δφ_{D})/J₄(Δφ_{D})]≦3 dB, we will attenuate modulation signal amplitude with a factor h to become (200 h)mV, and we can obtain the effective Δφ_{D} approaching to 4.2 rads (to suit this condition we can observe the waveform of the output interference signal like FIG. 6 with six extreme values). Then we can calculate the measurement result L_{PI, m, measure} (m=1˜7) according to Eq. (18). The test procedures are similar to standard PI measurement of the PIFOMI, and the measurement results are listed in table 1-1 and table 1-2. The difference L_{differ, m}=|L_{PI, m}−L_{PI, m, measure}| and the Standard Deviation Sₘ for all measurements are also listed in table 1-1 and table 1-2.

From table 1-1 and table 1-2, the maximum L_{differ,7} is 3.9 mm and maximum S₅ is 0.49 mm for all measurements. We can obviously observe when the PI is larger (for example, L_{PI,6}=777.1 mm, and L_{PI,7}=996.6 mm), and then L_{differ,m} are larger (L_{differ,6}=2.7 mm for L_{PI,6}, and L_{differ,7}=3.9 mm for L_{PI,7}). The main reason may be caused by slightly nonlinear from total current modulated process. Otherwise, when the PI is less than about 600 mm we can obtain the L_{differ,m}≦2 mm and S≦0.49 mm (for m≦5) based on the standard PIFOMI with path imbalance 98.6 mm in our PI measurement system. Additionally, according to our experiences, the PIs of the two-arm fiber optic interferometric sensors (using DFB laser diode as optical source) are mostly less than 200 mm. In our experiment, when the PI is up to about 200 mm we have obtained L_{differ,1}≦1 mm and S₁≦0.06 mm based on the system.

(C) Field Application of PI Measurement of the PIFOMI

For field application to construct the two arms fiber interferometer, the balance (or fixed PI) of two long sensing fiber arms are required, and therefore we must develop the proper method to measure the PI of the long sensing fiber and standard reference fiber.

In this experiment, we have made a standard reference fiber by 6 mm diameter PE outer jacket loose tube fiber with the length about 185 m according to the length mark of the fiber cable and with connectors at both ends. We can repeatedly make a same construction sensing fiber whose length is nearly equal to the reference fiber.

Firstly, the length of the preliminary sensing fiber (50) is cut longer than the length of the reference fiber (51) about 20 cm according to the mark, and then we measure the length (ΔL_{PI}) of the PI between the reference fiber (51) and the preliminary sensing fiber (50) by using the PI measurement system (the preliminary sensing fiber and the reference fiber are connected to A port and B port, respectively). The excess length of the preliminary sensing fiber is equal to (ΔL_{PI}−98.6 mm).

Then the preliminary sensing fiber is cut and we build a connector to the end to obtain the sensing fiber for field application. Note that the fabricating process of sensing fiber must be precisely control let the length of sensing fiber equal to the reference fiber. Finally, we measure the PI between the sensing fiber and the reference fiber by using the PI measurement system (the sensing fiber and the reference fiber are connected to A port and B port, respectively). The test procedures are similar to standard PI measurement of the PIFOMI, but the value ΔL_{PI} of the PI is directly obtained from one time measurement during 300s for field application to reduce measuring time efficiently.

In order to confirm reliability and stability of the PI measurement system, we have executed similar experiments independently within three days, and we obtain three values of (ΔL_{PI}−98.6 mm) are 4.82 mm, 4.34 mm, and 4.71 mm, respectively. The difference between maximum and minimum of these measurement results approximates 0.48 mm, and the standard deviation S is 0.27 mm. The PI (mean value is 4.62 mm) between the sensing fiber and the standard reference fiber is major caused by the fabricating processes of the cutting and the connector, and in the future we can modified the processes to reduce the length of the PI. These experiments verify the accuracy of the PI measurement system is only slightly affected while the lengths of the fiber arms of the PIFOMI are large (up to a few hundred meters), which is a big advantage of the PI measurement system.

### 4. Conclusion

The PI of the two-arm TAFOI is an important parameter for two major reasons.

Firstly, the phase noise of the output interference signal of the two-arm TAFOI is proportional to the PI, and the nearly zero PI is required to reduce the phase noise.

Secondly, the sensing phase signal of two-arm FOIS requiring linear demodulation by using PGC demodulator has many advantages, and the constant PI is required to generate constant carrier phase signal amplitude to avoid using PZT phase modulator for field application. The accuracy of the PI (the length of PI may be up to 200 mm for PGC demodulator) of two applications must achieve the order of millimeter. When the sensing fiber is produced by loose tube fiber or the sensing fiber length is more than a few hundred meters, the error of initial cutting fiber length can approximate a few decimeters, so we need a method that the PI detecting range can achieve a few decimeters and its accuracy can be in the order of millimeter. Currently, methods to measure larger OPD include using OLCR and mmOTDR. Although OLCR has high resolution, its OPD measuring range is generally a few centimeters. On the other hand, the resolution of mmOTDR is limited in about 5 mm. So both methods can not fit the demands above. In this paper, we propose a method to measure the PI by using the output interference signal of the PIFOMI. In the theoretical analysis, we use Bessel function to expand the interference signal, and use the specific relation between the second and fourth harmonic components of the interference signal to develop a theory to measure the PI of the PIFOMI. This method can measure a few decimeters of PI and its accuracy can reach the order of millimeter.

In our experiments, when the PI is less than about 600 mm we can obtain the L_{differ, m}≦2 mm and S≦0.49 mm, and when the PI is less than about 200 mm we have obtained the L_{differ}≦1 mm and S≦0.06 mm based on the PI measurement system. The PIs of the two-arm fiber optic interferometric sensors (using DFB laser diode as optical source) are mostly less than 200 mm. Therefore, the PI range and accuracy of the PI measurement system fit the requirements. Additionally, the field application experiment also verifies the accuracy of the PI measurement system is only slightly affected with the lengths of the fiber arms up to a few hundred meters, which is an important advantage of the PI measurement system.

While the preferred embodiment of the invention has been described above, it will be recognized and understood that various modifications may be made therein and the appended claims are intended to cover all such modifications that may fall within the spirit and scope of the invention.

I claim:

1. Path imbalance measurement of the two arms fiber optic interferometer comprising:
Using a current carrier signal to modulate the semiconductor laser source of an interferometer to let the interferometer output interference signal to generate a carrier phase signal by means of path imbalance value ΔL of said interferometer, said interference signals expanded to be harmonic components of carrier phase signal frequency by Bessel function, specific relation between the second and the fourth harmonic components of said interference signals used to develop the measurement theory of said path imbalance value ΔL, this method able to measure a few decimeters of said path imbalance and the accuracy of this method able to reach to millimeters.

2. The path imbalance measurement of the two arms fiber optic interferometer as claimed in claim 1, wherein a current modulation signal Δi sin ω_{c}t can be used to modulate said semiconductor laser source of the interferometer to output an interference signal that can generate a carrier phase signal
$$Δ φ ( t ) = \frac{2 π Δ Ln}{c} Δ i \frac{δ v}{δ i} sin {ω}_{c} t = Δ {φ}_{0} sin {ω}_{c} t ,$$
and an output power intensity of said semiconductor laser modulated from I₀ to I₀(1+α sin ω_{c}t), where α should be proportional to Δi to form an interference signal output I(t), of unbalanced PIFOMI, I(t)=b(1+α sin ω_{c}t){1+k cos [φ(t)+Δφ sin ω_{c}t]}, which can be expanded by using said Bessel function to attain four angular frequencies ω_{c}, 2ω_{c}, 3ω_{c}, 4ω_{c}, the amplitudes of said harmonic components respectively expressed as follows:
A(ω_{c})=bα−2bkJ₁(Δφ₀)sin φ(t)+[bαkJ₀(Δφ₀)−bαkJ₂(Δφ₀)] cos φ(t);
A(2ω_{c})=[2bkJ₂(Δφ₀)] cos φ(t)+[bαkJ₁(Δφ₀)−bαkJ₃(Δφ₀)] sin φ(t);
A(3ω_{c})=[bαkJ₂(Δφ₀)−bαkJ₄(Δφ₀)] cos φ(t)−[2bkJ₃(Δφ₀)] sin φ(t);
A(4ω_{c})=[2bkJ₄(Δφ₀)] cos φ(t)+[bαkJ₃(Δφ₀)−bαkJ₅(Δφ₀)] sin φ(t)∘
When sin φ(t)=0, the results are given below:
A(ω_{c})=[bαkJ₀(Δφ₀)−bαkJ₂(Δφ₀)] cos φ(t);
A(2ω_{c})=[2bkJ₂(Δφ₀)] cos φ(t);
A(3ω_{c})=[bαkJ₂(Δφ₀)−bαkJ₄(Δφ₀)] cos φ(t);
A(4ω_{c})=[2bkJ₄(Δφ₀)] cos φ(t)∘
The ratio of A(2ω_{c})/A(4ω_{c})=J₂(Δφ₀)/J₄(Δφ₀) depends on the amplitude of the modulation phase signal Δφ₀ (irrelevant to a), when Δφ₀ is limited in a specified range of J₂(Δφ₀)>0 (0<Δφ₀<5.135 rads), J₂(Δφ₀)/J₄(Δφ₀) and Δφ₀ is one-to-one correspondence function; the condition of sin φ(t)=0 is able to be accomplished by adjusting DC bias voltage to a PZT phase modulator on the two arm fiber optic interferometer and the frequency spectrums of interference signal output, and I(t) is able to be analyzed by a frequency spectrum analyzer, with the value of J₂(Δφ₀)/J₄(Δφ₀) able to be obtained for calculating the value of corresponding Δφ₀ from 2ω_{c} and 4ω_{c} said harmonic components.

3. The path imbalance measurement of the two arm fiber optic interferometer as claimed in claim 2, wherein the value of J₂(Δφ₀)/J₄(Δφ₀) obtained from 2ω_{c} and 4ω_{c} said harmonic components can be replaced by 20 log [J₂(Δφ₀)/J₄(Δφ₀)].

4. The path imbalance measurement of the two arms fiber optic interferometer as claimed in claim 2, wherein to reduce the influence of background noises and improve accuracy and stability, ideal experiment procedures are reasonably required in measurement to make sure that 20 log [J₂(Δφ₀)/J₄(Δφ₀)] is within the range of −3 dB≦20 log [J₂(Δφ₀)/J₄(Δφ₀)]≦3 dB to draw the values of A(2ω_{c}) and A(4ω_{c}) as near as possible for avoiding either of them being affected by noises, in other words, an ideal range being 3.927 rads≦Δφ₀≦4.429 rads.

5. The path imbalance measurement of the two arms fiber optic interferometer as claimed in claim 4, wherein in order to measure path imbalance of said polarization-sensitive fiber optic Michelson interferometer (PIFOMI), it must satisfy sin φ(t)=0 to let the values of A(2ω_{c}) and A(4ω_{c}) become maximum, and then the correct value of 20 log [J₂ (Δφ₀)/J₄ (Δφ₀)] can be obtained; the phase φ(t) is likely to produce dynamic variation together with environment condition, such as temperature, vibration and sound pressure, therefore, a periodic PZT phase modulator must be used to generate a phase signal φ_{PZT}(t) (the amplitude of φ_{PZT}(t) much greater than π rads) to let the total phase biased become φ_{T}(t)=φ(t)φ_{PZT}(t) and ensure that the condition of sin φ_{T}(t)=0 will certainly be attained several times within a voltage signal period (T), with a triangle wave signal able to be used as an ideal voltage signal; simultaneously a frequency spectrum analyzer (FSA) is used to continuously analyze the frequency spectrum of the output interference signal to certainly attain almost accurate value of 20 log [J₂(Δφ₀)/J₄(Δφ₀)] under the condition of sin φ_{T}(t)=0, letting the values of A(2ω_{c}) and A(4ω_{c}) become maximum.

6. The path imbalance measurement of the two arms fiber optic interferometer as claimed in claim 5, wherein within several voltage signal periods (T), the program will automatically choose several (expressed by N) output interference signals whose second harmonic spectrum components reaches maximum value and after being calculated, several (N) phase values can be obtained and their average phase is Δφ_{0,k} to be the result of measurement, able to reduce the influence of environment noises and insure measurement accuracy by means of said average phase.

7. The path imbalance measurement of the two arms fiber optic interferometer as claimed in claim 5, wherein said interference signals choose several (N) maximum values to be calculated, and N=5 is an example of this invention, thus able to attain a very accurate measurement result.

8. The path imbalance measurement of the two arms fiber interferometer as claimed in claim 1, wherein a PZT phase modulator is used to generate a phase signal to reach a condition of sin φ_{T}(t)=0 and at this time the values of A(2ω_{c}) and A(4ω_{c}) become maximum.

9. Path imbalance measurement of the two arm fiber optic interferometer at least comprising:
A polarization-insensitive fiber optic Michelson interferometer (PIFOMI) used to measure the value of path imbalance, said PIFOMI consisting of two Faraday rotator mirrors (FRM) that can eliminate polarization fading, one of the two arms of said PIFOMI provided with a PZT phase modulator to generate phase shift and in a certain period, pick several sets of interference signals whose second and fourth harmonic components respectively reach maximum value for getting several sets of measurement values of path imbalance, said several sets of measurement values of path imbalance averaged out to be an average measurement value of said path imbalance of said interferometer, said average measurement value able to be used to reduce the influence of environment noises and insure measuring accuracy.

10. The path imbalance measurement of the two arms fiber optic interferometer as claimed in claim 9, wherein said PZT phase modulator functions to change the phase shift of arm (B) of said interferometer.

11. The path imbalance measurement of the two arm fiber optic interferometer as claimed in claim 9, wherein a given path imbalance value ΔL_{R} (as reference of measurement) of the two arms of said standard PIFOMI must be measured by precise technique (to measure by an accurate rule).

12. The path imbalance measurement of the two arms fiber optic interferometer as claimed in claim 9, wherein to measure the path imbalance difference ΔL_{D} by using PIFOMI, ideal experiment procedures should be properly arranged in the measurement to make sure that 20 log [J₂(Δφ₀)/J₄(Δφ₀)] lies in −3 dB≦20 log [J₂(Δφ₀)/J₄(Δφ₀)]≦3 dB, that is, Δφ₀ is in the range of 3.927 rads≦Δφ₀≦4.429 rads, in measurement, proper experiment procedures arranged as follows:
(a) If
$$0.935 \leq \frac{Δ {L}_{D}}{Δ {L}_{R}} \leq 1.054 ,$$
current modulation signal Δi₀ sin ω_{c}t kept unchanged, and the amplitude Δφ_{D} still tallying with the demand of −3 dB≦20 log [J₂(Δφ_{D})/J₄(Δφ_{D})]≦3 dB, ΔL_{D} able to be obtained from the equation ΔL_{D}=(Δφ_{D}/Δφ_{R})ΔL_{R}; and
(b) If
$$0.935 > \frac{Δ {L}_{D}}{Δ {L}_{R}}$$ [symbol]
$$1.054 < \frac{Δ {L}_{D}}{Δ {L}_{R}} ,$$
said current modulation signal is multiplied by a coefficient(h) to become as hΔi₀ sin ω_{c}t, letting the amplitude Δφ_{D} of said modulation phase signal still meet the demand of −3 dB≦20 log [J₂(Δφ_{D})/J₄(Δφ_{D})]≦3 dB, ΔL_{D} able to be obtained from the equation
$$Δ {L}_{D} = \frac{Δ {φ}_{D}}{h Δ {φ}_{R}} Δ {L}_{R} .$$
